(19) United States
(12) Patent Application Publication
(10) Pub. No.: US 2009/0013303 A1
(43) Pub. Date: Jan. 8, 2009

(54) METHOD OF CREATING MASK LAYOUT IMAGE AND IMAGING SYSTEM

(75) Inventors: Chan Hwang, Seoul (KR); Han-Ku Cho, Gyeonggi-do (KR); Suk-joo Lee, Gyeonggi-do (KR)

Correspondence Address: MYERS BIGEL SIBLEY & SAJOVEC, PO BOX 37428, RALEIGH, NC, 27627, US

(73) Assignee: Samsung Electronies Co., Ltd.

(21) Appl. No.: 12/167,411

(22) Filed: Jul. 3, 2008

(30) Foreign Application Priority Data
Jul. 5, 2007 (KR) 10-2007-0067748

(51) Int. Cl. G06F 17/50

(52) U.S. Cl. 716/19

(57) ABSTRACT

Provided are a method of creating a mask layout image from a target image, a computer readable storage medium having stored thereon a computer program for executing the method, and an imaging system. The method includes reading all or a part of a target image to be transcribed on a substrate; defining a mask data set including a plurality of pixels having a predetermined transmittance characteristic; defining a weighting function having a non-zero value within a critical range; defining a convolution kernel determined by an illumination meter; and creating the mask layout image that minimizes an image fitting function by using the weighting function and the convolution kernel.

### CROSS-REFERENCE TO RELATED PATENT APPLICATION

This application claims the benefit of Korean Patent Application No. 10-2007-0067748, filed on Jul. 5, 2007, in the Korean Intellectual Property Office, the disclosure of which is incorporated herein in its entirety by reference.

### BACKGROUND OF THE INVENTION

The present invention relates generally to semiconductor devices, and more particularly, to systems and methods for manufacturing semiconductor devices.

Due to development of photolithography technology, scale reduction of large scale integrated circuits (LSIs) has been accelerated. Currently, design rules for manufacturing semiconductor devices are continuously reduced and scale reduction reaches 90 nm, 65 nm, 45 nm, and even a smaller size than 45 nm. As a result, the size of a pattern transcribed on a wafer becomes actually smaller than the wavelength of an exposure beam and thus an optical proximity effect caused by diffraction and interference of the exposure beam becomes a critical factor that determines limitation of resolution. Optical proximity correction (OPC) is regarded to be essential for performing patterning more precisely and more reliably.

In order to overcome the optical proximity effect and to obtain an optimal lithography result, an OPC technology using an inverse lithography technology (ILT) may be used. The ILT is a technology for finding an optimal mask pattern that may create a desired target image within a range of predetermined tolerances in a predetermined imaging system.

In general, the optimal mask pattern obtained by using the ILT includes assist features which control quantity of light transmitted through apertures between mask images by controlling the size of the apertures. Well-known examples of the assist features include scattering bars, serifs, and hammer heads.

Such assist features are not shown on a wafer when the wafer is actually exposed. However, the assist features may raise lithography costs by doubling the amount of layout data and increasing recording time when a mask layout image is manufactured. Furthermore, the lithography costs may also be raised because the assist features are not created completely automatically in accordance with a mask tone that is used.

### SUMMARY OF THE INVENTION

The present invention provides a method of creating a mask layout image by using an inverse lithography technology (ILT) by which assist features may be automatically created without limitation on a mask tone, a computer readable storage medium having stored thereon a computer program for executing the method, and an imaging system.

According to an aspect of the present invention, there is provided a method of creating a mask layout image, the method comprising: reading all or a part of a target image to be transcribed on a substrate; defining a mask data set including a plurality of pixels having a predetermined transmittance characteristic; defining a weighting function having a non-zero value within a critical range; defining a convolution kernel determined by an illumination meter; and creating the mask layout image that minimizes a value of an image fitting function by using the weighting function and the convolution kernel.

In some embodiments of the present invention, the mask layout image may be a binary mask, a mask having a gray scale transmittance value, a phase change mask or a combination thereof.

In some embodiments of the present invention, the weighting function may have a value greater than 0 and equal to or less than 1 within the critical range, and has the value 0 out of the critical range. The convolution kernel may be determined from a transmittance cross-coefficient (TCC).

According to embodiments of the present invention, by using a weighting function having a none-zero value with a predetermined critical range and a convolution kernel, a mask layout pattern with high contrast and high fidelity can be obtained. The critical range may be determined in consideration of various tones of a mask field and, therefore, a mask layout pattern may be easily formed regardless of the tones of the mask field.

According to another aspect of the present invention, there is provided an imaging system, comprising: a reading unit for reading all or a part of a target image to be transcribed on a substrate; and an operating unit for defining a mask data set including a plurality of pixels having a predetermined transmittance characteristic, defining a weighting function having a none-zero value within a critical range, defining a convolution kernel defined by an illumination meter, and creating the mask layout image that minimizes a value of an image fitting function by using the weighting function and the convolution kernel.

### BRIEF DESCRIPTION OF THE DRAWINGS

The above and other features and advantages of the present invention will become more apparent by describing in detail exemplary embodiments thereof with reference to the attached drawings in which:

FIG. 1 is a graph illustrating the relationship between a weighting function and an mask layout image in one dimension, according to an embodiment of the present invention;

FIGS. 2A and 2B are diagrams respectively illustrating optimal mask layout images which are obtained when dipole and quadrupole illumination meters are used, according to embodiments of the present invention; and

FIG. 3 is a diagram of an imaging system for creating an optimal mask layout image, according to an embodiment of the present invention.

### DETAILED DESCRIPTION OF THE INVENTION

Hereinafter, the present invention will be described in detail by explaining embodiments of the invention with reference to the attached drawings.

The invention may, however, be embodied in many different forms and should not be construed as being limited to the embodiments set forth herein; rather, these embodiments are provided so that this disclosure will be thorough and complete, and will fully convey the concept of the invention to those of ordinary skill in the art.

It will also be understood that when a layer is referred to as being “on” another layer or substrate, it can be directly on the other layer or substrate, or intervening layers may also be present. In the drawings, the thicknesses of layers and regions are exaggerated for clarity. Like reference numerals in the drawings denote like elements. As used herein, the term “and/or” refers to one of or a combination of at least two of listed items.

The terminology used herein is for the purpose of describing particular embodiments and is not intended to limiting the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In an inverse lithography algorithm, a weighting function and a convolution kernel may be used. Embodiments of the present invention provide a method and system for creating assist features by which a superior result may be promptly and simply obtained by optimizing the weighting function and the convolution kernel.

As shown in Equation 1, in order to determine an optimal mask function m(\vec{x}), an image fitting function F(m(\vec{x})) defined by a Euclidean distance ∥·∥₂ may be used. When the image fitting function F(m(\vec{x})) has a minimum value, the mask function m(\vec{x}) may be optimized.

$$\begin{matrix}F ( m ( {x}^{->} ) ) = ‖ \sqrt{w ( {x}^{->} )} {( ( I ( {x}^{->} ) - {I}_{ideal} ( {x}^{->} ) ) ‖}^{2} \\ = {\sum }_{n} W ( n ) \{ I ( n ) I ( n ) + I ( n ) {I}_{ideal} ( n ) + \\ {I}_{ideal} ( n ) {I}_{ideal (} ) I ( n ) \} ,\end{matrix} \qquad ( 1 )$$

where I(\vec{x}) represents a mask layout image obtained by the mask function m(\vec{x}), I_{ideal}(\vec{x}) represents an ideal image or a target image to be transcribed on a substrate, m(\vec{x}) represents a weighting function, and x represents a vector indicating positions of the substrate and a mask.

In some embodiments of the present invention, the mask function m(\vec{x}) may have a value 0 when the wafer has a shape and have a value 1 when the wafer does not have a shape. That is, m(\vec{x})={0, 1}. In this case, the optimized mask function m(\vec{x}) defines a binary mask. According to another embodiment of the present invention, the mask function m(\vec{x}) may be defined according to a gray scale transmittance value between the binary values 0 and 1. According to another embodiment of the present invention, the mask function m(\vec{x}) may be defined to be a phase change mask function by including a negative value.

Optical distortion may be modeled into a convolution linear system of a point spread function (PSF) h(\vec{x}) so as to be represented as shown in Equation 2. In this case, a complex amplitude A(\vec{x}) of an electro-magnetic field may be defined by Equation 3.

I(\vec{x})=|h(\vec{x})*m(\vec{x})|² (2)

A(\vec{x})=h(\vec{x})*m(\vec{x}) (3)

Referring back to Equation 1, according to an embodiment of the present invention, the weighting function w(\vec{x}) may have a selected value between the values 0 and 1 in accordance with the mask position \vec{x}. According to another embodiment of the present invention, in accordance with a value of the mask layout image I(\vec{x}), the weighting function w(\vec{x}) may have a value within a limited range, for example, between a first value, i.e., I min and a second value, i.e., I max that is greater than the first value I min, and have the value 0 out of the range.

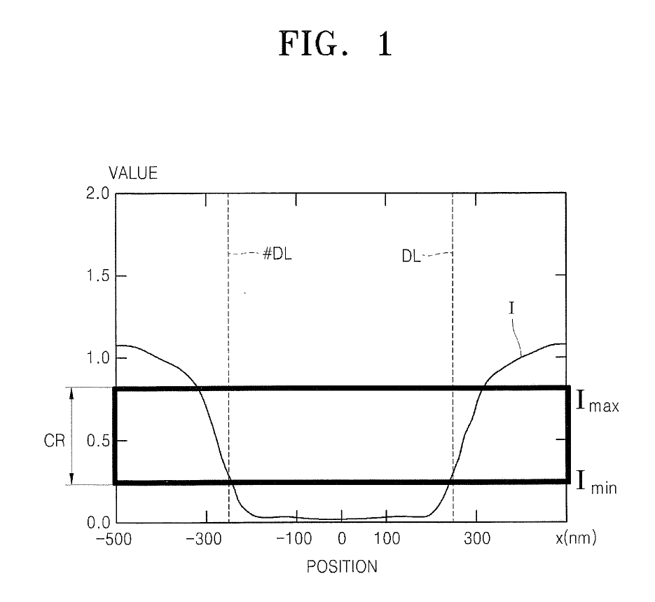

FIG. 1 is a graph illustrating the relationship between a weighting function w(\vec{x}) and a mask layout image I(\vec{x}) in one dimension, according to the above-described embodiment of the present invention. In FIG. 1, dotted lines #DL and DL represent edges of a target image and a curve I represents a mask function I(\vec{x}) in accordance with a position \vec{x}.

The weighting function w(\vec{x}) may have a non-zero value only within a predetermined critical range defined by the first values Iₘᵢₙ and the second value Iₘₐₓ. For example, the first and second values Iₘᵢₙ and Iₘₐₓ may respectively be 0.25 and 0.80. If the weighting function w(\vec{x}) has a non-zero value only within the critical range, a mask layout pattern will have high contrast and fidelity. According to an embodiment of the present invention, the critical range may be determined in accordance with various tones of a mask field. As a result, according to an embodiment of the present invention, a mask layout pattern including an assist pattern may be easily formed regardless of the tones of the mask field.

Referring back to Equation 1, the optimized mask function m(\vec{x}) minimizes the value of image fitting function F(m(\vec{x})). In order to obtain a solution of the optimized mask function m(\vec{x}) that minimizes the value of the image fitting function F(m(\vec{x})), an operation of a gradient descent algorithm may be repeatedly performed so as to satisfy Equation 4.

$$\begin{matrix}\frac{\partial F}{\partial m ( k )} = 2 \sum w ( n ) \{ I ( n ) - {I}_{ideal} ( n ) \} A ( n ) h ( k - n ) \\ = {\sum }_{Kernel} B ( n ) h ( k - n ) ,\end{matrix} \\ where B ( n ) = 2 w ( n ) \{ I ( n ) - {I}_{ideal} ( n ) \} A ( n ) . \qquad ( 4 )$$

In Equation 4, the PSF h(\vec{x}) is a convolution kernel and may be differently defined in accordance with an illumination meter that is used. The illumination meter may be a projection lithography system including various types such as an appropriate refractive optical system using vacuum or immersion fluid, a reflective optical system, and a catadioptric optical system.

In an embodiment of the present invention, a kernel that is defined in a defocused state is used as the convolution kernel. Most imaging illumination meters are subject to an incoherent aberration issue such as image blurring due to the limited size of a light source and a coherent aberration issue such as a Fresnel diffraction effect. If the kernel that is defined in a defocused state is used, a mask layout image may be created in consideration of the incoherent and coherent aberrations and thus a focus margin of an optical system may be increased in an actual photolithography process. In an embodiment of the present invention, a primary kernel defined from a transmittance cross-coefficient (TCC) in a defocused state may be used as the convolution kernel.

In an embodiment of the present invention, in order to easily obtain a solution on the optimized mask function m(\vec{x}), convergence of Equation 4 may be promoted in consideration of an intermediate mask function φ(\vec{x}). In consideration of a 2-phase mask as an intermediate mask, Equation 4 may be modified into Equation 5. The primary kernel defined from the TCC in a defocused state is used. The optimized mask function m(\vec{x}) that is ultimately obtained is represented by the curve I illustrated in FIG. 1. In an embodiment of the present invention, if the 2-phase mask is used, the optimal mask function m(\vec{x}) may be represented by Equation 6.

$$\begin{matrix}\frac{\partial F}{\partial ϕ} = \frac{\partial F}{\partial m} \frac{\partial m}{\partial ϕ} = ( B ( {x}^{->} ) * h ( {x}^{->} ) ) \frac{\partial m}{\partial ϕ} & ( 5 ) \\ \begin{matrix}m ( k ) = h ( ϕ ( k ) ) \\ = ( \frac{1}{2} + \frac{4}{π} a tan ( c ϕ ( k ) ) ) a max + ( \frac{1}{2} - \frac{4}{π} a tan ( c ϕ ( k ) ) a min\end{matrix} & ( 6 )\end{matrix}$$

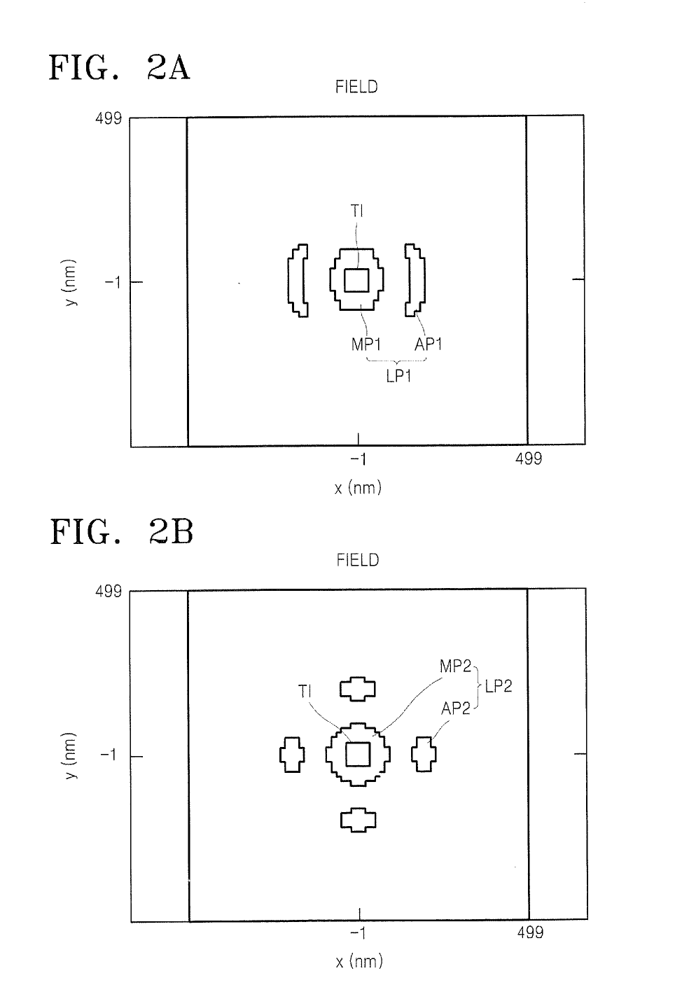

FIGS. 2A and 2B are diagrams respectively illustrating optimized mask layout images LP1 and LP2 which are obtained when dipole and quadrupole illumination meters are used, according to embodiments of the present invention. In FIGS. 2A and 2B, each of rectangles TI illustrated by a solid line represents a target image. The mask layout image LP1 is implemented by a main mask feature MP1 and an assist feature AP1 adjacent to the main mask feature MP1, and the mask layout image LP2 is implemented by a main mask feature MP2 and an assist feature AP2 adjacent to the main mask feature MP2. According to an embodiment of the present invention, it may be understood that assist features having high fidelity and sufficient contrast may be automatically created regardless of the type of an illumination meter that is used.

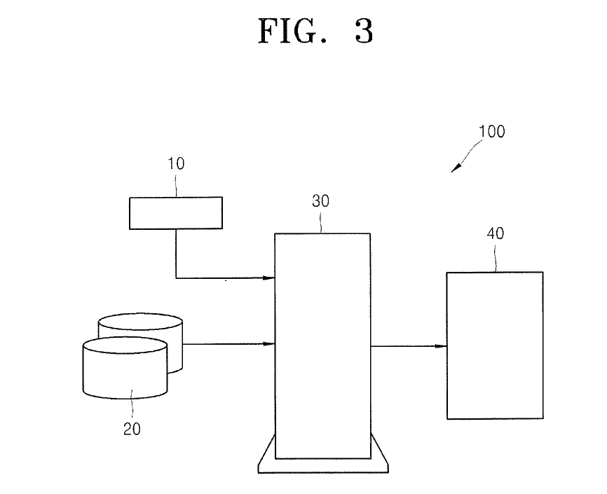

FIG. 3 is a diagram of an imaging system 100 for creating an optimized mask layout image, according to an embodiment of the present invention.

Referring to FIG. 3, a computer system 30 includes a processor (not shown) for executing at least one computer program, and executes a sequence of instructions which are stored by a program storage medium 10 such as a compact disk (CD) or a digital video disk (DVD), or are transmitted through a wired or wireless communication network such as the Internet. The computer system executes an instruction to read all or a part of a layout file from a layout file storage 20 such as a database or another storage medium. For example, the layout file may be a GDS II file generated by a general layout tool such as Or CAD^{R}. The computer system 30 defines a plurality of discrete pixels for a mask layout pattern from the layout file. If transmittance characteristics of the discrete pixels are calculated, I_{ideal}(\vec{x}) of the above described Equation 1 may be defined.

After I_{ideal}(\vec{x}) is defined, the computer system 30 may optimize the mask layout image I(\vec{x}) that minimizes the value of the image fitting function F (m(\vec{x})) by repeatedly performing a gradient descent algorithm. In this case, the PSF h(\vec{x}) that is a convolution kernel defined by an illumination meter and the weighting function w(\vec{x}) having a non-zero value only within a predetermined critical range may be used. If the optimized mask function m(\vec{x}) is obtained, mask layout data is transmitted to a mask recording device 40 such that a mask or a reticle is manufactured.

In this specification, a computer-readable storage medium refers to a general removable storage device such as a floppy disk, a hard disk drive, CD-ROM, or a magnetic tape, or a semiconductor storage device such as DRAM, SRAM, or flash memory. However, examples of the computer-readable storage medium are not limited thereto.

The present invention comprises various embodiments including the above-explained embodiments and embodiments described below.

1) According to another aspect of the present invention, there is provided a computer readable storage medium storing a sequence of programmed instructions for executing the above explained method.

2) In the above 1) the computer readable storage medium, the mask layout image may be a binary mask, a mask having a gray scale transmittance value, a phase change mask or a combination thereof.

3) In the above 1) the computer readable storage medium, the weighting function may have a value greater than 0 and equal to or less than 1 within the critical range, and has 0 out of the critical range.

4) In the above 1) the computer readable storage medium, the critical range may be determined in consideration of various tones of a mask field.

5) In the above 1) the computer readable storage medium, the mask layout image may be obtained by repeatedly performing an operation of a gradient descent algorithm.

6) In the above 1) the computer readable storage medium, the illumination meter is a projection lithography system.

7) In the above 1) the computer readable storage medium, the convolution kernel may be determined in a defocused state of the illumination meter.

8) In the above 7) the computer readable storage medium, the convolution kernel may be determined from a transmittance cross-coefficient (TCC).

9) In the above 1) the computer readable storage medium, the computer readable storage medium may further comprise a programmed instruction for minimizing the image fitting function by using an intermediate mask function.

According to the above embodiments of the present invention, a mask layout pattern having high contrast and fidelity may be obtained by using a weighting function having a non-zero value only within a predetermined critical range. Furthermore, the critical range may be determined in consideration of various tones of a mask field and thus an assist pattern may be automatically generated regardless of the tone of the mask field.

While the present invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of creating a mask layout image, the method comprising:
reading all or a part of a target image to be transcribed on a substrate;
defining a mask data set including a plurality of pixels having a predetermined transmittance characteristic;
defining a weighting function having a non-zero value within a critical range;
defining a convolution kernel determined by an illumination meter; and
creating the mask layout image that minimizes a value of an image fitting function by using the weighting function and the convolution kernel.

2. The method of claim 1, wherein the mask layout image is a binary mask, a mask having a gray scale transmittance value, a phase change mask or a combination thereof.

3. The method of claim 1, wherein the weighting function has a value greater than 0 and equal to or less than 1 within the critical range, and has the value 0 out of the critical range.

4. The method of claim 1, wherein the critical range is determined in consideration of various tones of a mask field.

5. The method of claim 1, wherein the mask layout image is obtained by repeatedly performing an operation of a gradient descent algorithm.

6. The method of claim 1, wherein the illumination meter is a projection lithography system.

7. The method of claim 1, wherein the convolution kernel is determined in a defocused state of the illumination meter.

8. The method of claim 7, wherein the convolution kernel is determined from a transmittance cross-coefficient (TCC).

9. The method of claim 1, further comprising minimizing the image fitting function by using an intermediate mask function.

10. An imaging system, comprising:
a reading unit for reading all or a part of a target image to be transcribed on a substrate; and
an operating unit for defining a mask data set including a plurality of pixels having a predetermined transmittance characteristic, defining a weighting function having a non-zero value within a critical range, defining a convolution kernel defined by an illumination meter, and creating the mask layout image that minimizes a value of an image fitting function by using the weighting function and the convolution kernel.

11. The imaging system of claim 10, wherein the mask layout image is a binary mask, a mask having a gray scale transmittance value, a phase change mask or a combination thereof.

12. The imaging system of claim 10, wherein the weighting function has a value greater than 0 and equal to or less than 1 within the critical range, and has the value 0 out of the critical range.

13. The imaging system of claim 10, wherein the critical range is determined in consideration of various tones of a mask field.

14. The imaging system of claim 10, wherein the mask layout image is obtained by repeatedly performing an operation of a gradient descent algorithm.

15. The imaging system of claim 10, wherein the illumination meter is a projection lithography system.

16. The imaging system of claim 10, wherein the convolution kernel is extracted in a defocused state of the illumination meter.

17. The imaging system of claim 16, wherein the convolution kernel is determined from a transmittance cross-coefficient (TCC).

18. The imaging system of claim 10, wherein the operating unit minimizes a value of the image fitting function by using an intermediate mask function.

19. The imaging system of claim 10, further comprising a mask recording device for recording the mask layout image on a mask.
